(19) United States
(12) Patent Application Publication
(10) Pub. No.: US 2026/0359594 A1
(43) Pub. Date: Nov. 12, 2026

(54) Wristbands Having a Plurality of Passive RF Inlays

(71) Applicant: Zebra Technologies Corporation, Lincolnshire, IL (US)

(72) Inventors: Steven J. Vandercar, Rolling Meadows, IL (US); Gene A. Hofer, Lake Zurich, IL (US); Joseph D. Moreira, Barrington, RI (US); Ryan J. Hurley, Wakefield, RI (US); Remi B. Lloyd, Middletown, RI (US)

(73) Assignee: Zebra Technologies Corporation, Lincolnshire, IL (US)

(21) Appl. No.: 19/200,961

(22) Filed: May 7, 2025

(51) Int. Cl. G06K 19/077; G06K 19/02; G06K 19/07

(52) U.S. Cl. CPC G06K 19/07762; G06K 19/025; G06K 19/072; G06K 19/07749

(57) ABSTRACT

A wristband has a flexible elongated body with an open state in which the wristband is capable of being positioned in a planar configuration and a closed state in which the wristband is wrapped in a loop. Multiple passive RF circuits are supported by the body and is positioned on the body such that the passive RF circuit is configured to be included in the loop when the wristband is in the closed state.

### BACKGROUND

Wristbands that include radiofrequency identification device (RFID) inlays typically suffer from readability issues due to interference from the body of the wearer of the wristband. The impact of the readability issues can vary based on a position of the RFID inlays relative to the body of the wearer and the RFID reader and can be particularly exasperated when the wrist or body of the wearer is positioned between the RFID inlay and the RFID reader.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a schematic plan view of an example of a wristband in accordance with embodiments of the present disclosure.

FIG. 1B is a schematic plan view of an example of a wristband in accordance with embodiments of the present disclosure.

FIG. 1C is a schematic profile view of an example of a wristband in accordance with embodiments of the present disclosure.

FIG. 2 is a schematic plan view of another example of a wristband in accordance with embodiments of the present disclosure.

FIG. 3 is a schematic plan view of another example of a wristband in accordance with embodiments of the present disclosure.

FIG. 4A-B are schematic plan view of other example wristbands in accordance with embodiments of the present disclosure.

FIG. 5A-B illustrates an embodiment of an example wristband in a closed state in which the wristband is wrapped in a loop in accordance with embodiments of the present disclosure.

FIG. 5C illustrates an embodiment of an example wristband in a closed state in which the wristband is wrapped in a loop about a wrist of a wearer in accordance with embodiments of the present disclosure.

FIG. 6 is a block diagram of an example embodiment of a passive RF circuit in accordance with embodiments of the present disclosure.

FIG. 7 illustrates an example of a system including an RF reader and a wristband in accordance with embodiments of the present disclosure.

FIG. 8 is a flowchart illustrating an example process in accordance with embodiments of the present disclosure.

FIG. 9 illustrates an example web of wristbands in accordance with embodiments of the present disclosure.

FIG. 10 illustrates an example sheet of wristbands in accordance with embodiments of the present disclosure.

FIG. 11A is a block diagram of an example media processing device in accordance with embodiments of the present disclosure.

FIG. 11B is a more detailed via of a supply of wristbands being processed by the media processing device of FIG. 11A in accordance with embodiments of the present disclosure.

FIG. 12 is a graph illustrating a read response of a passive RF circuit in an example wristband having conductive elements similar to those shown in FIGS. 1A-C.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRPTION

Embodiments of the present disclosure are related to systems and/or devices that include a wristband with multiple passive radiofrequency (RF) circuits and provide for enhanced readability of the wristband. As an example, the RF circuits can be distributed along a length of the wristband to advantageously increase the read range of the wristband and/or can increase the read angle of the wristband and can aid in overcoming the effect and/or impact of radiofrequency interference caused by a body of the wearer of the wristband. The RF circuits can extend circumferentially around the wristband when the wristband is wrapped around the wrist, ankle, or other body part of the wearer such that one or more of the RF circuits are unobstructed by the wrist or other body part even if the other RF circuits on the wristband are obstructed. The impact on readability of the wristband based on the orientation of the wristband about the wrist or other body parts of the wearer can be mitigated by embodiments of the present disclosure.

In accordance with embodiments of the present disclosure, a device is disclosed that includes a wristband having a flexible elongated body and passive radiofrequency (RF) circuits. The wristband has an open state in which the wristband is capable of being positioned in a planar configuration and having a closed state in which the wristband is wrapped in a loop such that a first end of the wristband overlaps a second end of the wristband and is fixed to the body. The passive RF circuits are supported by the elongated body of the wristband and are positioned along a length of the body such that the passive RF circuits are included in the loop when the wristband is in the closed state. The passive RF circuits are spaced away from each other and extend circumferentially about the loop in the closed state.

In accordance with embodiments of the present disclosure, a method is disclosed. The method includes obtaining a substrate of a wristband. The substrate has an elongated flexible body configurable between an open state in which the substrate is capable of being positioned in a planar configuration and a closed state in which the substrate is wrapped in a loop such that a first end of the substrate overlaps a second end of the substrate and is operatively fixed relative to the second end. The method also includes disposing a first passive radiofrequency (RF) circuit on the substrate. The first passive RF circuit is positioned on the substrate such that the first passive RF circuit is included in the loop when the wristband is in the closed state, a length of the first passive RF circuit is between 20% and 50% of a length of the substrate of the wristband. The method also includes disposing a second passive RF circuit on the substrate. The second passive RF circuit is positioned on the substrate such that the second passive RF circuit is included in the loop when the wristband is in the closed state, a length of the second passive RF circuit is between 20% and 50% of the length of the substrate of the wristband.

In accordance with embodiments of the present disclosure, a media processing device is disclosed. The media processing device includes a radiofrequency (RF) encoder, a printhead, a sensor, and a logic circuit. The sensor is configured to sense demarcation features on a supply of wristbands, where each wristband of the supply includes a printable surface and multiple passive RF circuits. The logic circuit is operatively coupled to the RF encoder, the printhead and the sensor, and is configured to register the printable surface of each wristband relative to the printhead based on an output of the sensor and register each of the plurality of passive RF circuits of each wristband relative to the RF encoder based on an output of the sensor.

In accordance with embodiments of the present disclosure, each of the plurality of passive RF circuits includes an electronic circuit and an antenna operatively coupled to the electronic circuit.

In accordance with embodiments of the present disclosure, the plurality of passive RF circuits are disposed along the length of the wristband such that each passive RF circuit of the plurality of passive RF circuits is spaced away from each other along the length.

In accordance with embodiments of the present disclosure, the plurality of passive RF circuits are disposed in a configuration where a first passive RF circuit of the plurality of passive RF circuits is disposed on a first side of a mid-line of the wristband and a second passive RF circuit of the plurality of passive RF circuits is disposed on a second side of the mid-line.

In accordance with embodiments of the present disclosure, the first passive RF circuit and the second passive RF circuit are asymmetrically disposed about the mid-line.

In accordance with embodiments of the present disclosure, a first passive RF circuit of the plurality of passive RF circuits is diametrically opposed to a second passive RF circuit of the plurality of passive RF circuits when the wristband is in the second state and a circumference of the loop is between four inches and eight inches.

In accordance with embodiments of the present disclosure, the plurality of passive RF circuits includes a first passive RF circuit, a second passive RF circuit, and a third passive RF circuit, wherein the first passive RF circuit and the second passive RF circuit are offset 120 degrees from the third passive RF circuit when the wristband is in the second state and a circumference of the loop is between four inches and eight inches.

In accordance with embodiments of the present disclosure, the plurality of passive RF circuits are disposed in a configuration where a first passive RF circuit of the plurality of passive RF circuits extends through a mid-line of the wristband, a second passive RF circuit of the plurality of passive RF circuits is disposed on a first side of the mid-line, and a third passive RF circuit of the plurality of passive RF circuits is disposed on a second side of the mid-line.

In accordance with embodiments of the present disclosure, a length of each of the plurality of passive RF circuits is between twenty percent (20%) and fifty percent (50%) of the total length of the wristband.

In accordance with embodiments of the present disclosure, the length of each of the plurality of passive RF circuits is configured based on the proportional relationship between the passive RF circuit length and the wristband length to uniformly space the plurality of passive RF circuits about a circumference of the loop when the wristband is in the closed state and the circumference of the loop is between four (4) inches and eight (8) inches.

In accordance with embodiments of the present disclosure, the plurality of passive RF circuits are distributed along the length of the wristband to mitigate interference with readability of at least one of the plurality of passive RF circuits when worn by a user.

In accordance with embodiments of the present disclosure, the length of two passive RF circuits of the plurality of passive RF circuits varies along the wristband such that the two passive RF circuits have different lengths.

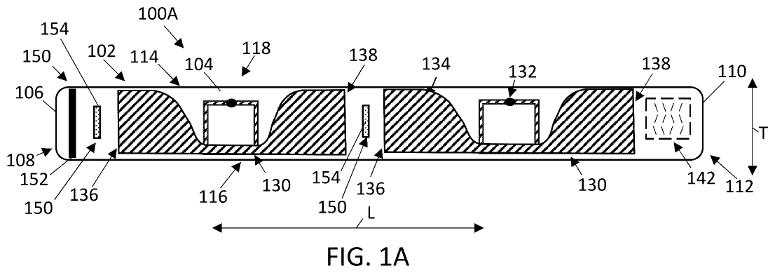

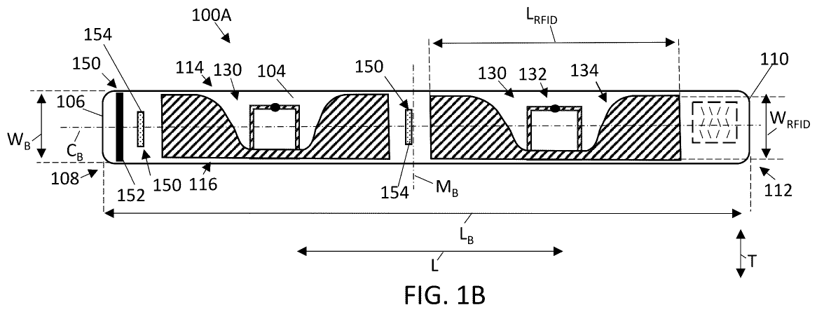

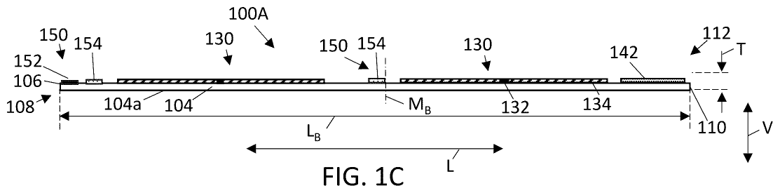

FIGS. 1A-C illustrate an example embodiment of a wristband or band 100A in an open position in accordance with embodiments of the present disclosure. FIGS. 1A-B are schematic plan views of the example wristband 100A and FIG. 1C is a schematic profile view of the example wristband 100A. The wristband 100A can have an elongated body 102, shown in FIGS. 1A-C in an open state in which the wristband 100A is capable of being positioned in a planar configuration. The body 102 can be formed from a flexible substrate 104. As an example, the substrate 104 can be formed from one or more of paper, elastomers polymers, and/or any combination thereof. Polymers used to form the substrate 104 can include, for example, polyesters, thermoplastic and/or vinyl polymers, such as polypropylene, polyethylene, polyethylene terephthalate, nylon, and/or Tyvek®, and/or any combination thereof. The substrate 104, or at least a portion thereof, provides a printable surface 104a, e.g., via thermal printing by a thermal printer.

The wristband 100A can be wrapped around a arm or wrist of a wearer (e.g., a human wearing the wristband). While the wristband 100A can be wrapped about the arm or wrist of the wearer, the wristband 100A can also be wrapped about other parts of the human body, such as a leg or an ankle, and/or can be wrapped about parts of animal's bodies, such as legs, neck, and/or other parts of the body.

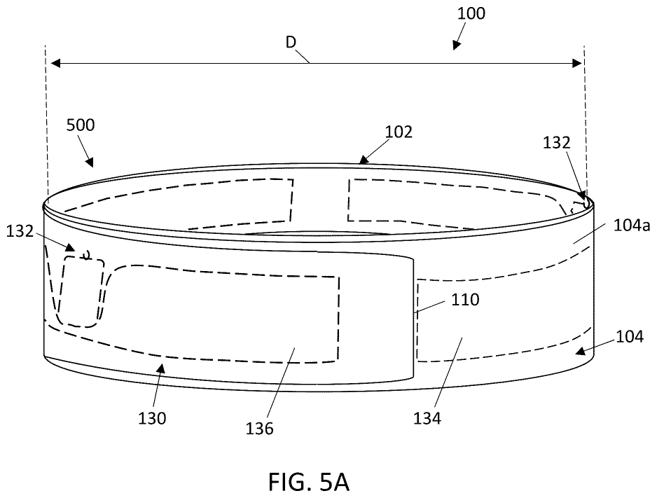

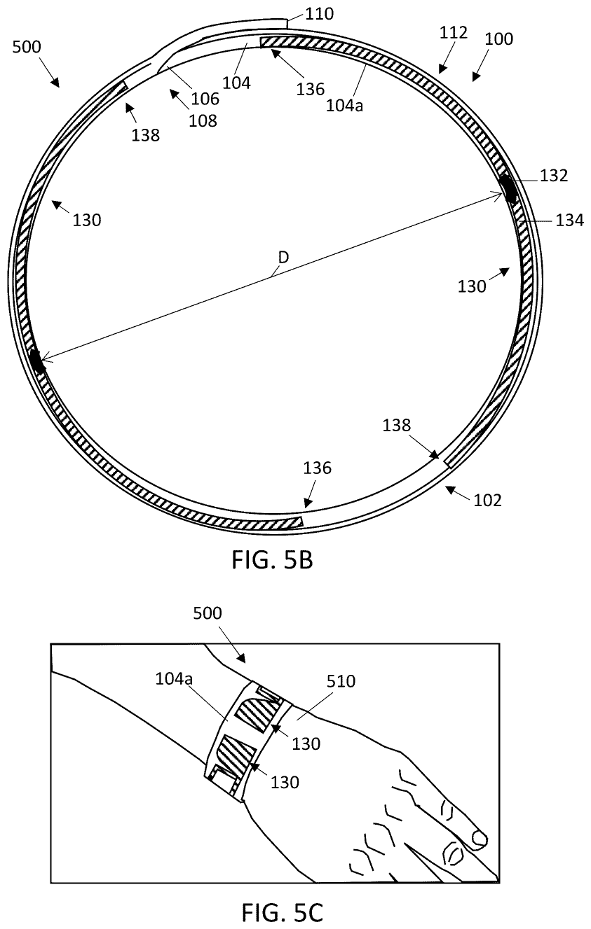

The body 102 can have a length L_{B} measured parallel to a longitudinal axis L from a terminal end 106 at a proximal end 108 of the body 102 to a terminal end 110 at a distal end 112. As used herein, proximal ends generally refer to ends of components on the left side in the orientation illustrated in FIGS. 1A-B and distal ends generally refer to ends of components on the right side in the orientation illustrated in FIGS. 1A-B. The length L_{B} of the body 102 can be between, for example, approximately five (5) inches and approximately twenty (20) inches or approximately seven (7) inches to approximately thirteen (13) inches. As shown in FIGS. 1A-C, the wristband 100A can have a first state in which the wristband 100 can be positioned in a planar configuration where the terminal ends 106 and 110 can be free. The wristband 100A can have a second state in which the wristband 100A forms a closed loop with one of the terminal ends overlapping the other one of the terminal ends (see, e.g., FIGS. 5A-C). The body 102 can have a width W_{B} measured parallel to a transverse axis T between a first edge 114 and a second edge 116 of the body 102. In one example, the width W_{B} can be between approximately one quarter (0.25) of an inch to approximately three (3) inches or between approximately one (1) inch and approximately two (2) inches. A thickness of the wristband 100A can be measured parallel to a vertical axis V shown in FIG. 1C. The transverse axis T, the longitudinal axis L, and the vertical axis V are each perpendicular to each other. In accordance with embodiments of the present disclosure, the width W_{B} of the wristband 100A can be generally uniform along the length L_{B} of the wristband 100A or the wristband 100A can be contoured such that the W_{B} varies along the length L_{B}.

Passive radiofrequency (RF) circuits 130a-b (collectively referred to as passive RF circuits 130) can be supported by the body 102. The passive RF circuits 130 can be devoid of a power source and can harvest power from radiofrequency waves via inductive coupling. The passive RF circuits 130 can include electronic circuits 132 and an antenna 134, which in the present example is illustrated as a dipole antenna. In the present example, the electronic circuits 132 are integrated circuits. While the antennas 134 are illustrated as being dipole antennas, embodiments of the present disclosure can include different types of antennas (e.g., slot antenna, patch antenna, etc.) and/or different antenna configurations or geometries (e.g., straight, curved, serpentine). The passive RF circuits 130 can be embodied as passive RF inlays, transponders, tags, or other form factors. In some embodiments, the lengths of the antennas 134 can be specified or tuned based on a wavelength of the radiofrequency communication to be received and/or transmitted by the passive RF circuits 130. As one example, the lengths of the antennas 134 can be equal to the wavelength, a fraction of the wavelength, such as three quarters of the wavelength, one half of the wavelength, one quarter of the wavelength, one eighth of the wavelength, or other fractions of the wavelength.

A length L_{RF} of each of the passive RF circuits 130 can extend longitudinally from a proximal end 136 of the RF circuits 130 to a distal end 138 of the RF circuits. As an example, in the illustrated embodiment, the length L_{RF} of each of the passive RF circuits 130 can be measured parallel to the longitudinal axis L, e.g., between the terminal ends of the antenna 134 in the present example. In one example, the length L_{RF} of each of the passive RF circuits 130 of the wristband 100A can be between approximately ten percent (10%) and fifty percent (50%) of the length L_{B} of the wristband 100A. The lengths of the different passive RF circuits 130 can be identical (e.g., passive RF circuits 130a and 130b can have the same length) or can be different (e.g., passive RF circuits 130a and 130b can have different lengths). A combined length of the passive RF circuits 130 of the wristband 100A can be between approximately twenty percent (20%) and one-hundred percent (100%) of the length L_{B} of the wristband 100A or between approximately fifty percent (50%) and eighty percent (80%) of the length L_{B} of the wristband 100A.

A width W_{RF} of each of the passive RF circuits 130 can be measured parallel to the transverse axis T. The width W_{RF} of each of the passive RF circuits 130 can vary along the longitudinal axis L based on, e.g., a design of the antennas 134. In one example, where the width W_{RF} varies along the longitudinal axis L, the measured width W_{RF} of the passive RF circuit 130 can be the maximum overall width determined by measuring, parallel to the transverse axis T, from a portion of the passive RF circuit 130 closest to the edge 114 to a portion of the passive RF circuit 130 closest to the edge 116. The width W_{RF} of each of the passive RF circuits 130 can be between approximately thirty percent (30%) to one-hundred percent (100%) of the width W_{B} of the wristband 100A or between approximately fifty percent (50%) to ninety percent (90%) of the width W_{B} of the wristband 100A.

The length L_{RF} and width W_{RF} of the passive RF circuit 130 can define a footprint of the passive RF circuit 130 having a corresponding surface area. The surface area of each of the passive RF circuits can be between approximately twenty percent (20%) to seventy-five percent (75%) of the surface area of the substrate 104 upon which the passive RF circuits 130 are disposed or between approximately forty percent (40%) to sixty percent (60%) of the surface of the substrate 104 upon which the passive RF circuits 130 are disposed. A combined surface area of the passive RF circuits 130 of the wristband 100A can be between approximately forty percent (40%) to one-hundred percent (100%) of the surface area of the substrate 104 upon which the passive RF circuits 130 are disposed or between approximately sixty percent (60%) to eighty percent (80%) of the surface area of the substrate 104 upon which the passive RF circuits 130 are disposed.

The length L_{RF}, width W_{RF}, and/or surface area (L_{RF}×W_{RF}) of the passive RF circuits130 can be important to the readability of the wristband 100A. The length L_{RF}, width W_{RF}, and/or surface area (L_{RF}×W_{RF}) of the passive RF circuit130 can be specified relative to the length L_{B}, width W_{B}, and/or surface area (L_{B}×W_{B}) of the wristband to mitigate the effects of radiofrequency interference while maximizing the inductive coupling effects of the antennas 134.

As shown in FIGS. 1A-C, the passive RF circuits 130 can be disposed along the length L_{B} of the wristband 100A and can each be spaced away from each other. In the present example, the passive RF circuit 130a can be disposed on a first side of a mid-line M_{B} extending parallel to the transverse axis T at a mid-point between the terminal ends 106 and 110 (or a mid-plane extending parallel to the transverse axis T and the vertical axis V). The passive RF circuit 130b can be disposed on a second side of the mid-line M_{B}. In one example, the passive RF circuits 130a-b can be disposed asymmetrically about the mid-line M_{B} (e.g., such that the passive RF circuit 130a is a first distance from the mid-line M_{B} and the passive RF circuit 130b is a second distance from the mid-line M_{B}, where the second distance is different from the first distance). In one example, the passive RF circuits 130a-b can be disposed symmetrically about the mid-line M_{B} (e.g., such that the passive RF circuits 130a and 130b are at the same distance from the mid-line M_{B}). While the passive RF circuits 130 can be disposed about the mid-point M_{B}, in exemplary embodiments one or more of the passive RF circuits 130 may extend through the mid-point M_{B}. In one example, when the wristband 100A is configured in the state to form the loop with a circumference between five inches and eight inches, the passive RF circuits 130a-b (e.g. the footprints of the RF circuits 130a-b), their respective electronic circuits 132, their respective proximal ends 136, and/or their respective distal ends 138 are diametrically opposed or offset 180 degrees from each other (see, e.g., FIG. 5A) or between 145 degrees and 235 degrees from each other.

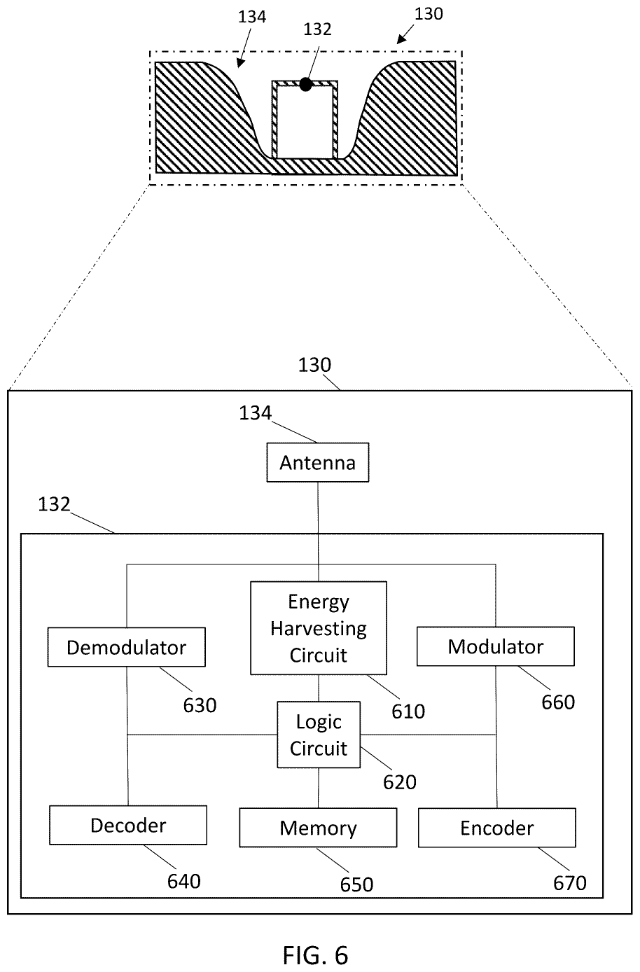

The passive RF circuits 130 can be readable as described herein by a corresponding radiofrequency device, such as a RF reader/interrogator. The passive RF circuit 130 can be an ultra-high frequency (UHF) RFID circuit configured for far-field radiofrequency communication (e.g., in a frequency range of approximately 860 MHz to approximately 960 MHz). As a non-limiting example, for embodiments in which the passive RF circuits are RFID circuits, the RFID circuits can be configured according to one or more proprietary schemes and/or according to one or more standards, such as ISO 18000-6A, ISO 18000-6B, ISO 18000-6C, ISO/IEC 29143, and/or other standards. The electronic circuit 132 of each passive RF circuit 130 can be electrically connected to the antenna 134 of the respective passive RF circuit 130, and the electronic circuit 132 of each passive RF circuit 130 can be operative to respond to far-field radiofrequency communication via the antenna 134. Each of the passive RF circuits 130 can be powered via inductive coupling in response to radiofrequency waves, e.g., emitted by the RF reader/interrogator, which induce an electric current in the antenna 134 that is used to power the electronic circuit 132. An example passive RF circuit 130 is described herein with reference to FIG. 6.

One or more coatings can be applied to the substrate 104 and/or the passive RF circuits 130. As a non-limiting example, the one or more coatings can include a silver antimicrobial coating, a varnish, and/or a soft feel coating. Additionally, or in the alternative, the RFD circuits 130 can be disposed between two substrates, e.g., the substrate 104 and another substrate 140, as shown in FIG. 1D, where the demarcation features 150 can appear on the substrate 140.

Referring to FIGS. 1A-C, the wristband 100A can include an adhesive 142 disposed at the terminal end 110, which can be used to affix the terminal end 110 to the body 102 to form a loop with the wristband 100A. The terminal end 110 and the adhesive 142 can form a tamper evident tab. The adhesive 142 can be disposed on the substrate 104 and/or the substrate 140.

The wristband 100A can include one or more demarcation features 150. In some examples, the one or more of the demarcation features 150 can be distributed along the length L_{B} of the wristband 100A. In one example, the one or more demarcation features 150 can include a first demarcation feature 152 and one or more second demarcation features 154. In one example, the second demarcation features 154 can be different from the first demarcation features, e.g., different in type (e.g., marks, gaps, notches), size (e.g., length and width), shape (e.g., rectangular, circular/oval, triangle), and/or color (e.g., black, blue, orange). The demarcation features 150 can be utilized during a printing and/or encoding operation to register the wristband 100A for printing and/or for encoding the passive RF circuits 130 and/or to calibrate a media processing device to a supply of wristbands 100A. In one example, the first demarcation feature 152 can be utilized by a media processing device for registering the wristband 100A for printing, while the second demarcation features 154 can be utilized by a media processing device for registering the passive RF circuits 130 of the wristband 100A for encoding. In one example, the first demarcation feature 152 can be utilized by a media processing device for registering the wristband 100A for printing and for registering one of the passive RF circuits (e.g., the passive RF circuit 130a) for encoding and the second demarcation feature 154 can be utilized by a media processing device for registering another one of the passive RF circuits (e.g., passive RF circuit 130b) for encoding. While the demarcation features 150 have been illustrated as marks on the surface of wristband 100A, exemplary embodiments of the wristband 100A can include other types of demarcation features 150 including, for example, gaps and/or notches.

While FIGS. 1A-C illustrate an example embodiment of the wristband having two passive RF circuits 130, exemplary embodiments of the wristband 100A can include more passive RF circuits 130, such as three passive RF circuits, four passive RF circuits, and so on.

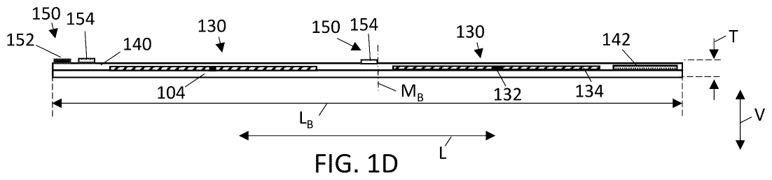

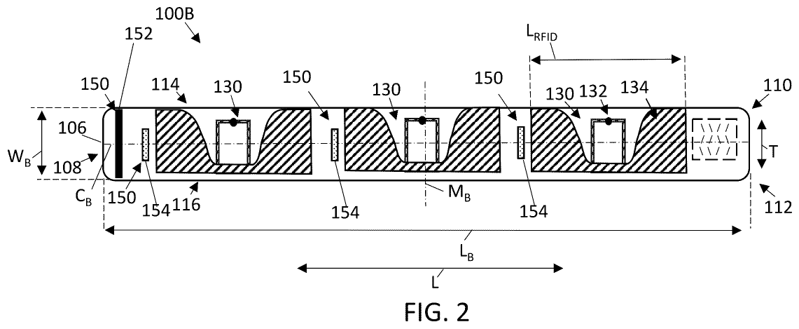

FIG. 2 illustrates another example wristband 100B in accordance with embodiments of the present disclosure. Generally speaking, the structure of the wristband 100B is similar in construction to the wristband 100A. Except where noted in the herein, the description of the wristband 100A and the components, properties, and features thereof, apply to the wristband 100B and for the sake of brevity will not be repeated. As shown in FIG. 3, the wristband 100B can include three passive RF circuits 130a-c disposed along the length L_{B} of the wristband 100B and can each be spaced away from each other. The length L_{RF} of each of the passive RF circuits 130a-c can be between approximately ten percent (10%) to fifty percent (50%) of the length L_{B} of the wristband 100B or between approximately twenty percent (20%) to thirty-five percent (35%). The width W_{RF} of each of the passive RF circuits 130a-c can be between approximately thirty percent (30%) to one hundred percent (100%) of the width W_{B} of the wristband 100A or between approximately fifty percent (50%) to ninety percent (90%) of the width W_{B} of the wristband 100A. The surface area of each of the passive RF circuits can be between approximately ten percent (10%) to thirty-five percent (35%) of the surface area of the substrate 104 upon which the passive RF circuits 130 are disposed. A combined surface area of the passive RF circuits 130 of the wristband 100A can be between approximately forty percent (40%) to one-hundred percent (100%) of the surface area of the substrate 104 upon which the passive RF circuits 130 are disposed or between approximately sixty percent (60%) to eighty percent (80%) of the surface area of the substrate 104 upon which the passive RF circuits 130 are disposed.

In the present example, the passive RF circuit 130a can be disposed on a first side of the mid-line M_{B} and the passive RF circuit 130b can be disposed on a second side of the mid-line M_{B}, while the passive RF circuit 130c can be positioned between the passive RF circuits 130a-b and can extend through the mid-line M_{B}. In one example, the passive RF circuits 130a-b can be disposed asymmetrically about the mid-line M_{B} (e.g., such that the passive RF circuit 130a is a first distance from the mid-line M_{B} and the passive RF circuit 130b is a second distance from the mid-line M_{B}, where the second distance is different from the first distance). In one example, the passive RF circuits 130a-b can be disposed symmetrically about the mid-line M_{B} (e.g., such that the passive RF circuits 130a and 130b are at the same distance from the mid-line M_{B}). In one example, a center of the passive RF circuit 130c (measured between ends of the passive RF circuit 130c along the longitudinal axis L) can be offset relative to the mid-line M_{B} of the wristband 100B and/or can be asymmetrically disposed about the mid-line M_{B}. In one example, the center of the passive RF circuit 130c can be aligned with the mid-line M_{B} of the wristband 100B and/or can be symmetrically disposed about the mid-line M_{B}. In one example, when the wristband 100A is configured in the state to form the loop with a circumference between four (4) inches and eight (8) inches, the passive RF circuits 130a-c (e.g., the footprint of the RF circuits 103), their respective electronic circuits 132, their respective proximal ends 136, and/or their respective distal ends 138 are offset 120 degrees from each other or between 100 degrees and 140 degrees from each other.

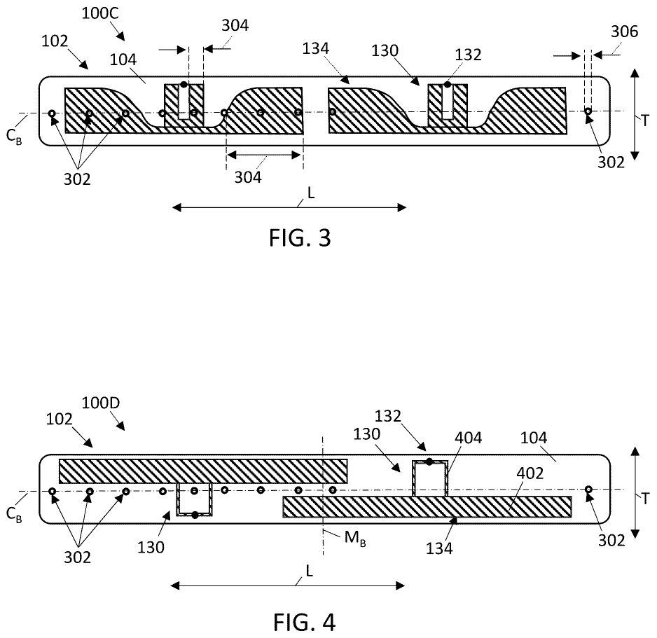

FIGS. 3 and 4 illustrate example wristbands 100C and 100D, respectively. Generally speaking, the structure of the wristbands 100C and 100D are similar in construction to the wristband 100A. Except where noted in the herein, the description of the wristband 100A and the components, properties, and features thereof, apply to the wristbands 100C and 100D and for the sake of brevity will not be repeated. The wristbands 100C and 100D can include holes 302 along the length L_{B} of the wristbands 100C and 100D as shown in FIGS. 3 and 4. One of the holes 302 at the distal end 110 of the wristbands 100C and 100D can be aligned with another one of the holes 302 along the body 102 when the wristbands 100C and 100D are placed in a loop and a clip can passed through the aligned holes 302 and secured to the wristbands 100C and 100D to affix the wristbands 100C and 100D in a loop. Alternatively, the clip can be formed at the distal end 110 and can mate with the holes 302 long the length L_{B} of the wristbands 100C and 100D. The holes 302 can pass through the substrate 104 (and/or the substrate 140) and portions of the passive RF circuits 130 as shown in FIG. 3 or can pass through the substrate 104 (and/or substrate 140) without passing through the passive RF circuits 130 as shown in FIG. 4.

As shown in FIG. 3, the holes 302 can be aligned along the center axis C_{B} and can pass through the antennas 336 of the passive RF circuits 130. The dimensions of the antennas 134 can be specified to ensure that the holes do not disrupt the electrical connectivity of the antenna to the electronic circuit 132. For example, a dimension 304 of the traces or conductive material(s) that form the antennas 134 along the center axis C_{B} can be at least one and half (1.5) times or two (2) times a diameter 306 of the holes 302 such that the holes 302.

As shown in FIG. 4, the holes 302 can be aligned along the center axis C_{B} and can pass through the antennas 336 of the passive RF circuits 130. The antennas 134 can avoid the holes 302 to ensure that the holes do not disrupt the electrical connectivity of the antenna to the electronic circuit 132. For example, a longitudinally extending portion 402 of the antennas 134 can extend along the longitudinal axis L on one side of the center axis C_{B} and a portion 404 of the antenna 134 can extend transversely parallel to the transverse axis T in a space between adjacent holes 302 to electrical connect the antenna 134 to the electronic circuit 132.

In one example, the passive RF circuit 130 b can be rotated 180 degrees relative to the passive RF circuit 130 such that the electronic circuits 132 of the passive RF circuits 130a-b and the longitudinally extending portions 402 of the antennas 134 can be on opposite sides of the center axis C_{B}. The portions 402 can be partially aligned or overlapping with each other along the transverse axis T and can extend through the mid-line M_{B}. The length of the portions 402 can each be between thirty percent (30%) and seventy-five percent (75%) of the length L_{B} of the wristband 100D or between fifty percent (50%) and seventy-five percent (75%) of the length L_{B} of the wristband 100D. The example antenna configuration illustrated in FIG. 4 can allow the antennas 134 to extend over more than fifty percent (50%) of the length LB of the wristband 100D while maintaining space between the passive RF circuits 130.

Any of the embodiments of the wristbands 100A-100D illustrated in FIGS. 1-4 can include the holes 302 and/or adhesive 142. Where neither the holes 302 nor the adhesive 142 is illustrated, the holes 302 and/or adhesive 142 have been omitted to allow the wristbands to be viewed without being obscured. Additionally, while the adhesive 142 and holes 302 have been illustrated in example positions on the wristband, the adhesive 142 and holes 302 can be positioned in other locations in accordance with embodiments of the present disclosure.

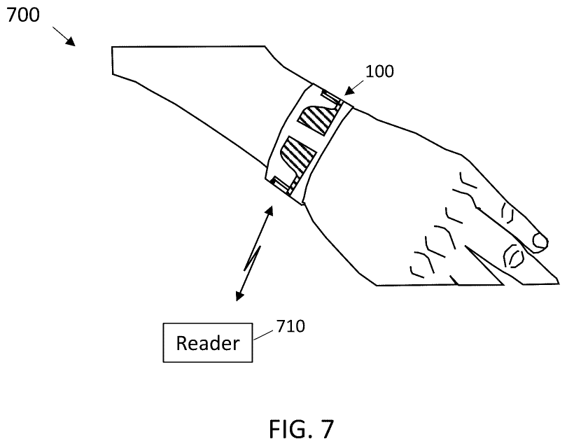

FIGS. 5A-C illustrate an example embodiment of the wristband 100 (e.g., representative of any one of the wristbands 100A-D) in a closed state such that the wristband 100 has a loop configuration in accordance with embodiments of the present disclosure. As shown in FIGS. 5A-C, the wristband 100 can have a second state in which the wristband is fixed in a loop 500 (e.g., where the wristband 100A is looped at least partially around itself and at least one of the terminal ends 106 or 110 is fixed or fastened to the body 102) to wrap the wristband 100 about a wearer of the wristband 100. The loop 500 can have a diameter D. The diameter D or the loop 500 can vary based on a size of the wearer. As an example, the diameter D of the loop 500 can be approximately one (1) inch to approximately seven (7) inches or approximately one and a half (1.5) inches to approximately four (4) inches. In the loop configuration, the passive RF circuits 130 are contained within the loop 500 and extend circumferentially around a wearer (e.g., a wrist 510 of the wearer). The passive RF circuits 130 is also contained in the loop 500 and extend circumferentially around the loop 500 (e.g., as opposed to flag style wristband where a passive RF circuit is not included in the loop). Because the passive RF circuits 130 are included in the loop 500, it is more likely that one or more of the passive RF circuits 130 will be positioned in a manner that interferes with the operation of the passive RF circuits 130. For example, when the loop 500 is wrapped about the wrist 510 of a wearer, the wrist 510 can interfere with reception of radiofrequency waves from a passive RF reader/interrogator (e.g., RF reader 710 shown in FIG. 7), particularly, for example, when the wrist 510 or body of the wearer is positioned between one or more of the passive RF circuits 130 and the RF reader (e.g., RF reader 710 shown in FIG. 7), such that the one or more of the passive RF circuits 130, for example, do not generate enough power from the inductive coupling to respond to the RF reader based on an electric current induced in the antennas of the one or more of the passive RF circuits 130 obstructed, e.g., by the wrist 510 or a body of the wearer. However, by including the multiple passive RF circuits 130 in the loop and having the passive RF circuits 130 distributed circumferentially in the loop, a sufficient electric current can be induced in at least one of the passive RF circuits 130 by the radiofrequency waves such that the at least one of the passive RF circuits 130 responds to an interrogation signal from the RF reader.

FIG. 6 is a block diagram of an example embodiment of the passive RF circuit 130 in accordance with embodiments of the present disclosure. As shown in FIG. 6, the electronic circuit 132 of the passive RF circuit 130 can include an energy harvesting circuit 610, a logic circuit 620, a demodulator 630, a decoder 640, memory 650, a modulator 660, and an encoder 670. As a non-limiting example, the electronic circuit 132 can be implemented as one or more integrated and/or discrete circuits.

The memory 650 is a non-transitory computer-readable medium that can include volatile (e.g., RAM) and/or non-volatile memory (e.g., EEPROM). The memory 650 can store data, including an identifier, which can be used in a system to identify and distinguish the passive RF circuit 130 from other passive RF circuits in a system and can also be used to associate the passive RF circuit 130 with an object in the system. In an example embodiment, the identifier can be a string of alphanumeric characters. The passive RF circuit 130 can be associated with the wristband 100 and/or can be associated with a person, animal, or object about which the wristband 100 is wrapped. For example, when passive RF circuit 130 of the wristband 100 is interrogated by an RF reader, the passive RF circuit 130 may respond with the stored identifier to identify itself and the RF reader and/or other devices can use the association between the identifier, the wristband 100, and/or the wearer of the wristband 100 to determine and/or retrieve information about the wearer, and/or the RF reader and/or other devices can perform one or more operations based on the receipt of the identifier and/or the information determined and/or retrieved about the wearer of the wristband 100 based on the identifier.

When the passive RF circuit 130 is within a read range of the RF reader/interrogator, radio waves of the far-field radiofrequency communication emitted by the RF reader can generate a time varying electromagnetic field, which in turn can induce, via inductive coupling, an electrical signal (e.g., an electric current) in the antenna 134. The electrical signal can be processed by the energy harvesting circuit 610 to generate a power supply voltage to power the components of the electronic circuit 132. For example, the energy harvesting circuit 610 receives the electrical signal from the antenna 134 and converts the electrical signal to a direct current voltage. The energy harvesting circuit 610 can include, for example, a charge pump, voltage converter, voltage regulator, and/or other circuitry. The electrical signal can also include information that can be demodulated by the demodulator 630 and decoded by the decoder 640. The decoded electrical signal can be received as an input by the logic circuit 620 from the decoder 640.

In response to receipt of the decoded electrical signal and when sufficient power is generated from the induced electrical current, the logic circuit 620 can retrieve data from the memory 650 (e.g., the identifier) and output the data to the encoder 670. The logic circuit 620 can include software, firmware, and/or hardware, or any combination thereof to facilitate the operations performed by the logic circuit 620. For example, the logic circuit 620 can include digital circuitry, such as logic gates. The encoder 670 can encode the data from the logic circuit 620 and output the encoded data to the modulator 660, which can modulate the encoded data and output the modulated data to the antenna 134 to modulate the modulated signal onto the far-field radiofrequency communication received by the passive RF circuit 130 from the RF reader.

While an example embodiment of the passive RF circuit 130 has been illustrated in FIG. 6, embodiments of the passive RF circuit 130 can include more, fewer, and/or different components. As an example, the passive RF circuit 130 can include any number of energy harvesting circuits, demodulators, decoders, logic circuits, encoders, and/or modulators.

FIG. 7 is an example environment 700 in accordance with embodiments of the present disclosure. The environment 700 can include far-field RF reader 710 and an embodiment of the wristband 100 (e.g., any one of wristbands 100A-D) wrapped in the loop 500 about a wrist of the wearer. The RF reader 710 can be disposed at a fixed or stationary location and/or can be moved to different locations. For example, the RF reader 710 can be spaced away from the passive RF circuits 130 of the wristband to facilitate far-field radiofrequency communication (e.g., RF reader 710 can be greater than twelve inches, two feet, three feet, four feet, five feet, six feet, seven feet, eight feet, or more from the passive RF circuits 130). The RF reader 710 can attempt to interrogate the passive RF circuits 130 by emitting a far-field radiofrequency communication. As described herein, when the wristband 100 is wrapped in a loop about the wrist of a wearer and the passive RF circuits 130 are included in the loop 500, the wrist 510 and/or other body parts can cause radiofrequency interfere with reception of radiofrequency waves from an RF reader/interrogator, particularly when the wrist 510 is positioned between the passive RF circuits 130 and the RF reader 710. The radiofrequency interference can reduce the read range of the passive RF circuits 130 such that the passive RF circuit 130 needs to be closer to the RF reader 710 than it normally would need to be without the radiofrequency interference, the power of the radiofrequency waves emitted by the RF reader 710 would need to be increase to compensate for the interference, or the orientation of the reader or the passive RF circuits would need to be adjusted. However, by including the multiple passive RF circuits 130 distributed in the loop formed by the wristband 100, as described herein, an electric current can be induced in an electric current in the antenna of at least one of the passive RF circuits 130.

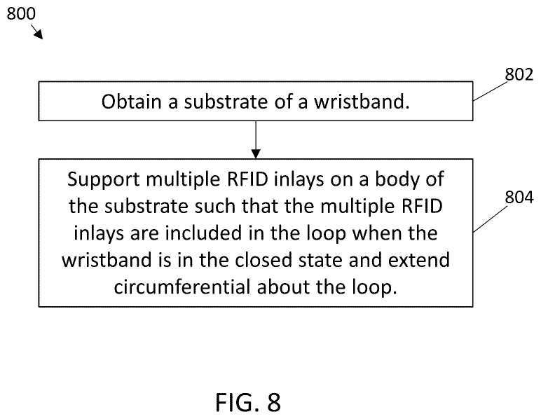

FIG. 8 is a flowchart illustrating an example process 800 of forming an example wristband (e.g., wristband 100) in accordance with embodiments of the present disclosure. At operation 802, a substrate of a wristband is obtained. At 804, multiple passive RF circuits (e.g., passive RF circuits 130) are supported by an elongated flexible body (e.g., body 102) of the substrate. The wristband has an open state in which the wristband is capable of being positioned in a planar configuration and has a closed state in which the wristband is wrapped in a loop (e.g., loop 500) such that a first end (e.g., terminal end 110) of the wristband overlaps a second end (e.g., terminal end 106) of the wristband and is fixed to the body. The passive RF circuits are supported by the body by positioning the passive RF circuits on the body such that the passive RF circuits are configured to be included in the loop when the wristband is in the closed state.

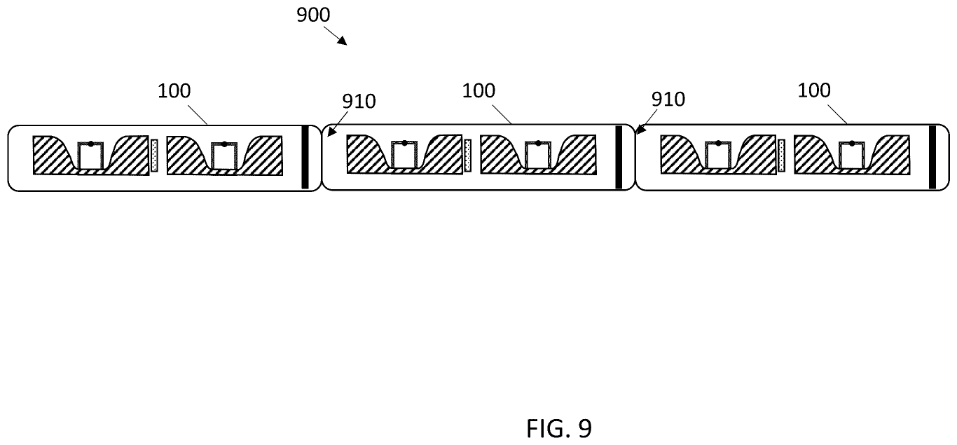

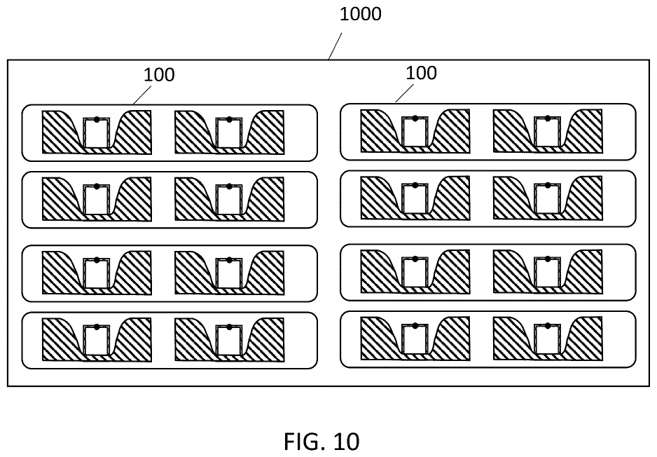

As shown in FIGS. 9 and 10, wristbands can be provided individually or can be included in a supply of wristbands 100 (e.g., anyone of the wristbands 100A-D). The individual wristbands 100 and supply of wristbands 100 can be configured to be processed by a media processing device, such as a printer and/or RF encoder. In one example, supply of wristbands can be received by a thermal printer that includes an RF encoder, where the thermal printer prints indica on the wristbands (e.g., the printable surface 104a) and encodes wristbands via the RF encoder. As shown in FIG. 9, a supply of wristbands 100 can be form a web 900 of wristbands 100 where the wristbands 100 are aligned end-to-end connected via lines of weakness 910 (e.g., perforations, scores). As shown in FIG. 10, a supply of wristbands 100 can be formed in a sheet 1000 of wristbands 100, where the wristbands 100 are distributed on and separatable from the sheet via die cuts, scores, and/or perforations.

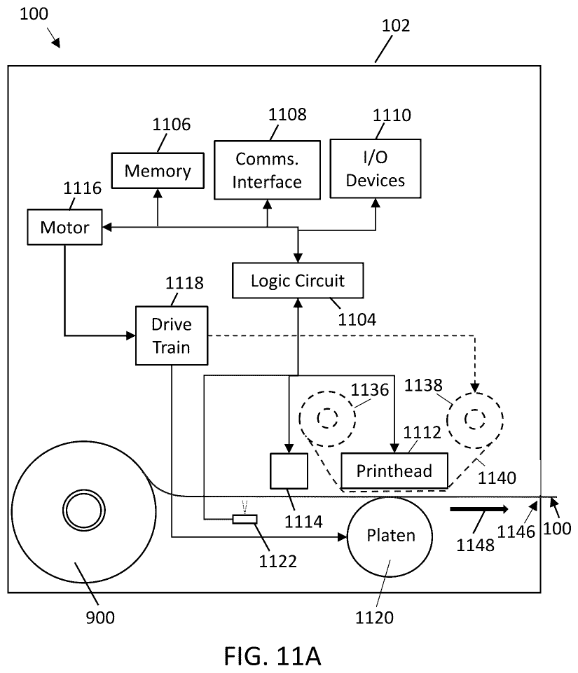

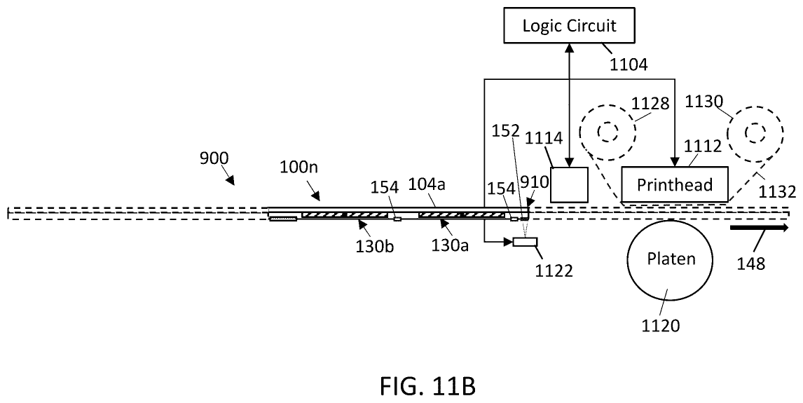

FIG. 11A illustrates a block diagram of an example media processing device 1100, such as a printer, in accordance with embodiments of the present disclosure. FIG. 11B is a detailed illustration of an interaction between the example media processing device 1100 and a supply of wristbands 100. With reference to FIGS. 11A-B, the media processing device 1100 can include a housing 1102. The housing 1102 contains or supports one or more components of the media processing device 1100 including, for example, a logic circuit 1104, memory 1106, a communication interface 1108 (e.g., for wired and wireless communication), input/output (I/O) devices 1110 (e.g., a display, switches, buttons, speakers, microphone, etc.), a printhead 1112, a radiofrequency encoder/reader 1114, a motor 1116, a drive train 1118, a platen roller 1120, and a demarcation sensor 1122.

The housing 1102 can be configured to contain an embodiment of supply of wristbands 100 (e.g., any one of the wristbands 100A-D). As an example, the housing 1102 can include a media chamber to store the web 900 of wristbands 100 as it is consumed by the media processing device 1100. The logic circuit 1104 can include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory 1106 is a non-transitory computer-readable medium that can include, for example, volatile (e.g., RAM, DRAM, SRAM, etc.) and/or non-volatile memory (e.g., ROM, PROM, EPROM, EEPROM, Flash memory device, optical memory device, magnetic memory device).

The logic circuit 1104 of the media processing device 1100 can be operatively coupled to the memory 1106, the communications interface 1108, the I/O devices 1110, the printhead 1112, the radiofrequency encoder/reader 1114, the motor 1116, and/or the sensor 1122. The platen roller 1120 can be driven by the motor 1116 via a drive train 1118 to rotate the platen roller 1120 about an axis of rotation in a first direction (e.g., clockwise in the orientation shown in FIGS. 11A-B) to pull the supply of wristbands 100 through the feed path in a feed direction denoted by the arrow 1148 and output the wristbands 100 from the media processing device via a media exit 1146 formed in the housing 1102 and can be driven by the motor 1116 via the drive train 1118 to rotate the platen roller 1120 about the axis of rotation in a second direction (e.g., counterclockwise in the orientation shown in FIG. 11B) to retract or back feed the wristbands 100 (in an opposite direction than the feed direction denoted by the arrow 1148). In one example, the logic circuit 1104 can be configured to execute code stored in the memory 1106 to perform operations and functions of the media processing device 1100, e.g., by communicating with and/or controlling one or more of the components of the media processing device 1100. In some embodiments, e.g., for thermal transfer printing, the media processing device 1100 can include a ribbon supply spindle 1128 and a ribbon take up spindle 1130 for supporting an ink ribbon 1132. For direct thermal embodiments, the media processing device 1100 can be devoid of the ribbon supply spindle 1128, the ribbon take-up spindle 1130, and the ink ribbon 1132. The logic circuit 1104 can execute the code stored memory 1106 to implement a printing operation or function that controls the motor 1116 to rotate the platen roller 1120 to feed the wristbands 100 past the printhead 1112, controls the printhead 1112 to print on the wristbands 100 (either directly or by transferring an ink from a ribbon to the media), and/or controls the RF encoder/reader 1114 to encode/write and/or read the passive RF circuits 130 of the wristbands 100. For thermal transfer printing, the printable surfaces of the wristbands 100 are configured to receive a pigment (e.g., resin, wax-resin, etc.) that is transferred from the ink ribbon 1132 installed on the ribbon supply and take-up spindles 1128 and 1130, respectively, via an operation of the printhead 1112. For direct thermal printing, the printhead 1112 of the media processing device 1100 can selectively heat the printable surface of the wristbands 100 triggering a chemical or physical change in a thermally sensitive dye covering at least a portion of the printable surface of the wristbands 100. After sequentially printing on the wristbands 100, the wristbands 100 can be further sequentially advanced and output from media processing device 1100 by the operation of the platen roller 1120.

With reference to FIGS. 11A-B, to ensure the printhead 1112 prints at specified or desired locations on the wristbands 100 as the wristbands 100 pass the printhead 1112 and/or to ensure that the encoder 1114 encodes the passive RF circuits 130 of the wristbands 100, the logic circuit 1104 can be configured to calibrate and/or register the wristbands 100 relative to the printhead 1112 and/or encoder 1114, based on an output of the demarcation sensor 1122, which is responsive to the demarcation features 150. Detection of the demarcation features 150 of the wristbands 100 can be used to locate the designated printing areas of the wristbands 100 and/or to locate the passive RF circuits 130 of the wristbands 100.

As an example, a wristband 100n of the supply of wristbands 100 is advanced along the feed path in the direction 1148 by the platen 1120. As the wristband 100n is transported, the demarcation sensor 1122 can sense the demarcation feature 152 at the proximal end of the wristband adjacent to the line of weakness 910 connecting the wristband 100n to a downstream wristband. Upon detection of the demarcation feature 152, the logic circuit 1104 of the media processing device 1100 can register the wristband 100n relative to the printhead 1112 and determines a distance that the wristband 100n needs to travel before controlling the printhead 1112 to print on the printable surface of the wristband 100n. For embodiments in which the motor 11116 is a stepper motor, the distance that the wristband needs to travel can correspond to a specified number of steps of the motor 1116. In addition to registering the wristband 100n to the printhead 1112, detection of the demarcation feature 152 can also register a first passive RF circuit 130a relative to the encoder 1114 and determines a distance that the wristband 100n needs to travel before controlling the encoder 1114 to encode the passive RF circuit 130a of the wristband 100n. Alternatively, the wristband 100n can include a separate demarcation feature 154-1 that can be sensed to register the passive RF circuit 130a to the encoder 1114. As the wristband 100n continue to travel along the feed path in the direction 1148, the demarcation sensor 1122 can sense another demarcation feature 154-2. Upon detection of the demarcation feature 154-2, the logic circuit 1104 can register a second passive RF circuit 130b relative to the encoder 1114 and determines a distance that the wristband 100n needs to travel before controlling the encoder 1114 to encode the passive RF circuit 130b of the wristband 100n. In one example, the passive RF circuits 130a-b can be encoded with identical information. When the demarcation senses the demarcation feature 152 or 154-1 of the next wristband in the sequence, the logic circuit 1104 can update the encoding instructions to encode the passive RF circuits 130 of the next wristband. This allows the logic circuit 1104 to encode multiple passive RF circuits of a wristband while tracking each wristband through the printing and/or encoding process.

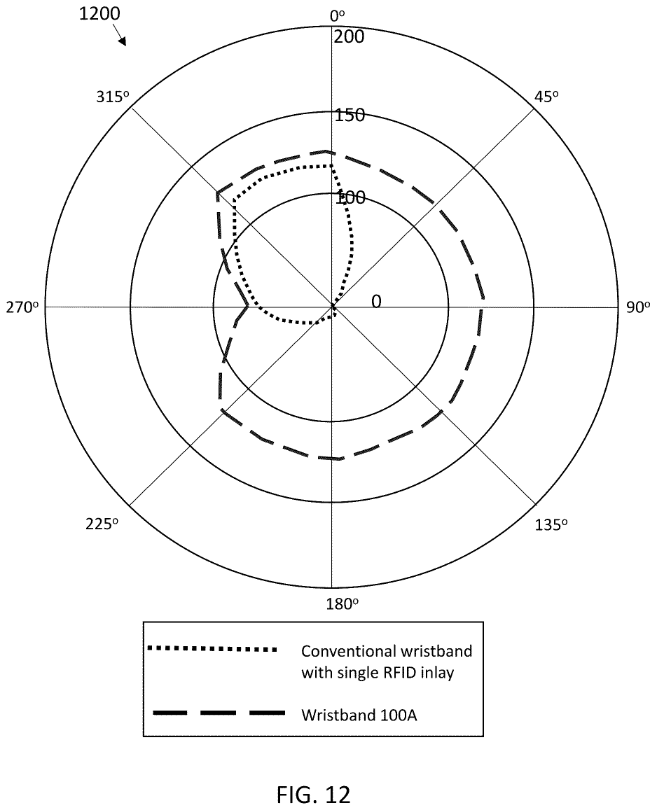

FIG. 12 illustrates an experimental result of a read response and orientation sensitivity of an example embodiment of the wristbands 100 described herein. The experimental setup is shown in FIG. 6, where the reader 710 is rotated circumferentially about the wristband or by rotating the wristband about circumferentially about the reader 710 by three hundred sixty 360 degrees. The experimental setup included the wristband being wrapped in a loop about a phantom arm that imitates an arm of a human for radiofrequency experiments and positioned the reader 710 at a distance of eight (8) feet from the wristband. The phantom arm utilized for the experiments was the SHO Generic Forearm Phantom CTIA Version 1 from Speag.

FIG. 12 is a graph 1200 illustrating an experimental read response and orientation sensitivity of an example wristband having a configuration illustrated in FIGS. 1A-C as well as in a wristband having a single passive RF circuit. The graph 1200 measures a quantity of reads/responses per twenty seconds radially from a center axis (which corresponds to 0 reads) by the concentric circles and measures a read angle from zero (0) degrees to three hundred sixty degrees (360) degrees circumferentially in a clockwise direction. As shown in FIG. 12, the read range of the wristband with the multiple passive RF circuits 130 distributed circumferentially around the loop of the wristband produced a greater read range than the wristband with a single passive RF circuit 130. The wristband with the multiple passive RF circuits 130 produced a greater read angle and read distance than the wristband that with the single passive RF circuit 130.

The above description refers to a block diagram of the accompanying drawings. Alternative implementations of the example represented by the block diagram include one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium,” “non-transitory computer-readable medium,” “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A device, comprising:
a wristband having a flexible elongated body, the wristband having an open state in which the wristband is capable of being positioned in a planar configuration and having a closed state in which the wristband is wrapped in a loop such that a first end of the wristband overlaps a second end of the wristband and is fixed to the body;
a plurality of passive radiofrequency (RF) circuits supported by the elongated body of the wristband, the plurality of passive RF circuits being positioned along a length of the body such that the plurality of passive RF circuits are configured to be included in the loop when the wristband is in the closed state, the plurality of passive RF circuits are spaced away from each other and extend circumferentially about the loop in the closed state.

2. The device of claim 1, wherein each of the plurality of passive RF circuits includes an electronic circuit and an antenna operatively coupled to the electronic circuit.

3. The device of claim 1, wherein the plurality of passive RF circuits are disposed along the length of the wristband such that each passive RF circuit of the plurality of passive RF circuits is spaced away from each other along the length.

4. The device of claim 1, wherein the plurality of passive RF circuits are disposed in a configuration where a first passive RF circuit of the plurality of passive RF circuits is disposed on a first side of a mid-line of the wristband and a second passive RF circuit of the plurality of passive RF circuits is disposed on a second side of the mid-line.

5. The device of claim 4, wherein the first passive RF circuit and the second passive RF circuit are asymmetrically disposed about the mid-line.

6. The device of claim 1, wherein a first passive RF circuit of the plurality of passive RF circuits is diametrically opposed to a second passive RF circuit of the plurality of passive RF circuits when the wristband is in the closed state and a circumference of the loop is between four inches and eight inches.

7. The device of claim 1, wherein the plurality of passive RF circuits includes a first passive RF circuit, a second passive RF circuit, and a third passive RF circuit,
wherein the first passive RF circuit and the second passive RF circuit are offset 120 degrees from the third passive RF circuit when the wristband is in the closed state and a circumference of the loop is between four inches and eight inches.

8. The device of claim 1, wherein the plurality of passive RF circuits are disposed in a configuration where a first passive RF circuit of the plurality of passive RF circuits extends through a mid-line of the wristband, a second passive RF circuit of the plurality of passive RF circuits is disposed on a first side of the mid-line, and a third passive RF circuit of the plurality of passive RF circuits is disposed on a second side of the mid-line.

9. The device of claim 1, wherein a length of each of the plurality of passive RF circuits is between twenty percent (20%) and fifty percent (50%) of the total length of the wristband.

10. The device of claim 1, wherein a length of each of the plurality of passive RF circuits is configured based on the proportional relationship between the passive RF circuit length and the wristband length to uniformly space the plurality of passive RF circuits about a circumference of the loop when the wristband is in the closed state and the circumference of the loop is between four (4) inches and eight (8) inches.

11. The device of claim 1, wherein the plurality of passive RF circuits are distributed along the length of the wristband to mitigate interference with readability of at least one of the plurality of passive RF circuits when worn by a user.

12. The device of claim 1, wherein a length of two passive RF circuits of the plurality of passive RF circuits varies along the wristband such that the two passive RF circuits have different lengths.

13. A method, comprising:
obtaining a substrate of a wristband, the substrate having an elongated flexible body configurable between an open state in which the substrate is capable of being positioned in a planar configuration and a closed state in which the substrate is wrapped in a loop such that a first end of the substrate overlaps a second end of the substrate and is operatively fixed relative to the second end;
disposing a first passive radiofrequency (RF) circuit on the substrate, the first passive RF circuit being positioned on the substrate such that the first passive RF circuit is configured to be included in the loop when the wristband is in the closed state, a length of the first passive RF circuit is between 20% and 50% of a length of the substrate of the wristband; and
disposing a second passive RF circuit on the substrate, the second passive RF circuit being positioned on the substrate such that the second passive RF circuit is configured to be included in the loop when the wristband is in the closed state, a length of the second passive RF circuit is between 20% and 50% of the length of the substrate of the wristband.

14. The method of claim 13, wherein each of the plurality of passive RF circuits includes an electronic circuit and an antenna operatively coupled to the electronic circuit.

15. The method of claim 13, wherein disposing the first and second passive RF circuits comprises:
disposing the first and second passive RF circuits along the length of the wristband such that each passive RF circuit of the plurality of passive RF circuits is spaced away from each other along the length.

16. The method of claim 13, wherein disposing the first and second passive RF circuits comprises:
disposing the first and second passive RF circuits in a configuration where a first passive RF circuit of the plurality of passive RF circuits is disposed on a first side of a mid-line of the wristband and a second passive RF circuit of the plurality of passive RF circuits is disposed on a second side of the mid-line.

17. The method of claim 13, wherein a first passive RF circuit of the plurality of passive RF circuits is diametrically opposed to a second passive RF circuit of the plurality of passive RF circuits when the wristband is in the closed state and a circumference of the loop is between four inches and eight inches.

18. The method of claim 13, further comprising:
disposing a third passive RF circuit on the substrate,
wherein the first passive RF circuit and the second passive RF circuit are offset 120 degrees from the third passive RF circuit when the wristband is in the closed state and a circumference of the loop is between four inches and eight inches.

19. (canceled)
